(19) United States
(12) Patent Application Publication
(10) Pub. No.: US 2025/0153747 A1
(43) Pub. Date: May 15, 2025

(54) METHOD FOR MONITORING THE EQUIVALENT CONICITY OF A RAIL VEHICLE-RAIL SYSTEM

(71) Applicant: Siemens Mobility GmbH, München, Bayern (DE)

(72) Inventors: Robert Mertens, Meerbusch, NRW (DE); Bernhard Andreas Stingl, Krefeld (DE); Kaspar Schroeder-Bodenstein, Düsseldorf (DE)

(21) Appl. No.: 18/728,749

(22) PCT Filed: Dec. 1, 2022
(86) PCT No.: PCT/EP2022/084095

§ 371 Date: Jul. 12, 2024

(30) Foreign Application Priority Data
Jan. 14, 2022 (DE) 10 2022 200 376.4

(51) Int. Cl. B61K 9/12; B61K 9/08; B61L 15/00; B61L 23/04; G01M 17/08

(52) U.S. Cl. CPC B61K 9/12; B61K 9/08; B61L 15/0081; B61L 15/009; B61L 23/042; G01M 17/08

(57) ABSTRACT

A method for operating a rail vehicle is provided, during which a running stability of the rail vehicle is detected using measurements, and a conicity prediction regarding a change in wheel profiles of the rail vehicle is determined by a computer taking into account a distance traveled. The running stability and the conicity prediction are used to make a distinction between a track section-caused change and a vehicle-caused change in the equivalent conicity. A data processing device or system, a computer program, a computer-readable data carrier, and a data carrier signal is also correspondingly provided.

### CROSS-REFERENCE TO RELATED APPLICATIONS

This application is a national stage of PCT Application No. PCT/EP2022/084095, having a filing date of Dec. 1, 2022, which claims priority to DE Application No. 10 2022 200 376.4, having a filing date of Jan. 14, 2022, the entire contents both of which are hereby incorporated by reference.

### FIELD OF TECHNOLOGY

The following relates to a method for operating a rail vehicle, during which a running stability of the rail vehicle is detected using measurements.

### BACKGROUND

When rail vehicles are traveling on rails, the running stability is essentially determined by the equivalent conicity of the contact between wheel and rail. This equivalent conicity results from the interaction between, on the one hand, the profile of the wheels of the rail vehicle, which is to say the conically profiled running surfaces of the wheels, and on the other hand track-related factors. These track-related factors are in particular the profile of the rail, which is to say the shape and the state of the surface of the railhead, and the distance between the rails, in particular the presence of gauge narrowings.

An increase in the equivalent conicity has an adverse effect on the running properties of the rail vehicle. Hunting increasingly occurs, and in extreme cases this can result in displacement of the sleeper framework. It is therefore desirable to discover and rectify an increased equivalent conicity, which can be caused both by the vehicle and by the track.

Document EP 3181428 A2 describes how the wheel conicity of one or more wheels of a rail vehicle is determined. What is referred to as the hunting frequency is determined on the basis of measured vibrations, wherein an increased wheel conicity can generate greater hunting frequencies.

Rail vehicles are frequently equipped with friction brake systems, in the case of which a braking action on the vehicle is triggered by friction elements pressing against one another, i.e., kinetic or potential energy of the vehicle is converted into heat energy. Shoe-type brakes are an example of such a friction brake system. They act directly on the wheels of the vehicle, which are therefore subjected to high thermomechanical loading and stressing in particular at high initial braking speeds. In embodiments, but not exclusively, for vehicles using shoe-type brakes it is expedient to use the method according to embodiments of the invention.

### SUMMARY

An aspect relates to a method for operating a rail vehicle which is intended to assist with monitoring the equivalent conicity of a rail vehicle rail system.

Embodiments of the invention also relate to a corresponding data processing device or system, a corresponding computer program, a corresponding computer-readable data carrier, and a corresponding data carrier signal.

In embodiments, the method according to embodiments of the invention for operating a rail vehicle involves detecting a running stability of the rail vehicle using measurements. Moreover, a conicity prediction regarding a change in wheel profiles of the rail vehicle is determined by a computer taking into account a distance traveled. Then, the running stability and the conicity prediction are used to make a distinction between a track-caused change and a vehicle-caused change in the equivalent conicity.

Since the equivalent conicity is influenced both by properties of the track, which is to say the rails, and by the state of the wheels of the rail vehicle, making a distinction between these two possible causes for an undesired increase in the equivalent conicity is helpful. This is because it is then possible to take suitable measures for rectifying the defect after such a distinction has been made, as a result of which the equivalent conicity can be reduced further. Suitable measures can in particular be refurbishment of the track and/or renovation of the wheel profile.

In order to make a decision about the most likely cause for an increase in the equivalent conicity, two variables are considered:
Firstly, the driving stability of the rail vehicle is determined. The driving stability results from an interaction between vehicle-related and track-related factors.
Secondly, the change in conicity is considered from the perspective of the driving operation alone, which is to say the natural or continuous increase which rises with the mileage in kilometers. This involves a prediction, since other than the distance traveled no measurement is taken, and instead a known relationship between the distance traveled and the change in conicity is utilized.

It is not necessary to make the distinction between track-related and vehicle-related causes such that the cause of the increase in conicity is definitively established. Instead, it is sufficient if the result output is that one of the two causes is the most probable one.

All the steps of the method according to embodiments of the invention are carried out in the rail vehicle. For this, the rail vehicle has suitable measuring devices, in particular for monitoring the running stability and measuring the distance, and also a data processing system for evaluating the measurements and making the distinction. The data processing system can also take or determine a suitable measure depending on the distinction made.

In a refinement of embodiments of the invention, to detect the running stability use is made of data from a measuring device, which takes acceleration measurements on the running gear frame of the rail vehicle. These acceleration data indicate the degree of hunting of the rail vehicle while it is being driven. The greater the equivalent conicity is, the higher the acceleration values measured in the middle of the running gear frame are.

It is particularly advantageous if, for the conicity prediction, the distance traveled since a wheel profiling is measured and a computation rule is used to determine an expected change in wheel profiles of the rail vehicle from this. During the wheel profiling, the wheels are worked such that they once again have a profile which is favorable for the equivalent conicity. The profile then becomes worse as the distance traveled increases. In this respect, the relationship between the distance traveled and the change in conicity may be linear or more complicated.

In one refinement of embodiments of the invention, the distinction is made by comparing the running stability and the conicity prediction with one another. This comparison can be made such that variables derived from the running stability and/or the conicity prediction are compared with one another. The two variables serve to indicate a change in the equivalent conicity. When the distinction is made, a decision can then be made that the track is the cause if the running stability or the variable derived therefrom indicates a greater change in the equivalent conicity than the conicity prediction or the variable derived therefrom, and a decision can be made that the vehicle is the cause if the running stability or the variable derived therefrom indicates the same change in the equivalent conicity as the conicity prediction or the variable derived therefrom. The decision can be made here using suitable limit or threshold values.

In an embodiment of the invention, if a decision is made that the track is the cause, location-related information is additionally incorporated to make it possible to locate track damage. If the equivalent conicity is thus increased because the track is the cause on a particular track section, it is possible to specifically arrange for the rails to be repaired there.

In one refinement of embodiments of the invention, the rail vehicle has shoe-type brakes. In that case, the detected data regarding performed braking operations of the shoe-type brake are taken as a basis to determine the heat energy content of the wheels, the data including brake pressures or braking forces, or brake torques and also kinematic variables such as wheel speeds or the driving speed of the rail vehicle. From this, a computer makes a second conicity prediction regarding a change in wheel profiles of the rail vehicle. In addition to the first conicity prediction, which results from the distance traveled, there is therefore a second conicity prediction, which is influenced by the braking behavior. As a result, the input of heat into the wheels causes deformation and consequently a change in the wheel profile which adversely affects the equivalent conicity. If the second conicity prediction is present, the distinction between track-related and vehicle-related changes can additionally be made using the second conicity prediction.

With preference, after the distinction is made, one or more of the following measures is taken:
Outputting a message regarding defects on the rails,
Outputting a message regarding defects on the wheels of the rail vehicle,
Outputting a message to the driver regarding the wheel state or a future braking behavior.
The first two messages are sent to a device located outside the rail vehicle.

The results of the method according to embodiments of the invention can be utilized by a data processing device or system, which comprises means for receiving, evaluating and storing information from multiple rail vehicles as regards a distinction made according to the described method between a track-caused change and a vehicle-caused change in the equivalent conicity. Since information from multiple rail vehicles is used, the plausibility of this information can be checked. If e.g., multiple rail vehicles on a particular track section output a track-caused increase in the equivalent conicity, there is a need for action to more closely investigate or repair this track section.

In embodiments, the method according to embodiments of the invention and/or one or more functions, features and/or steps of the method according to embodiments of the invention and/or one of its embodiments can be computer-assisted. One or more mutually interacting computer programs are used for this. If multiple programs are used, they can be stored together on and run by a computer, or on different computers at different locations. Since this functionally means the same thing, “the computer program” and “the computer” are worded in the singular in the present case.

### BRIEF DESCRIPTION

Some of the embodiments will be described in detail, with reference to the following figures, wherein like designations denote like members, wherein:

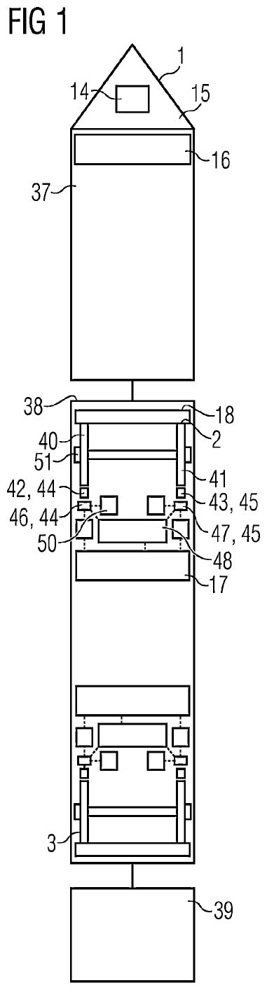

FIG. 1: shows a rail vehicle; and

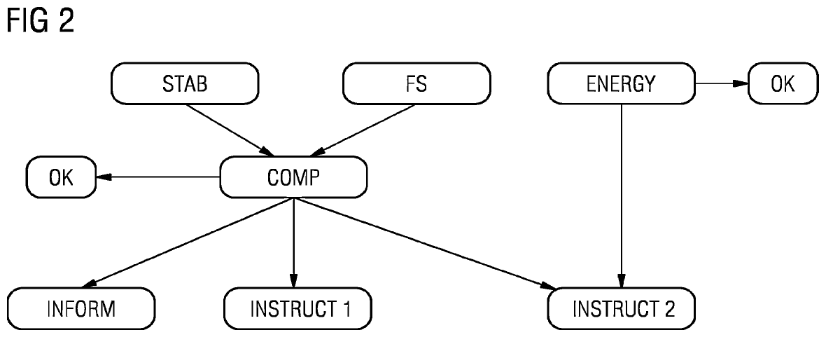

FIG. 2: shows a method sequence.

### DETAILED DESCRIPTION

FIG. 1 shows a track-guided vehicle in the form of a rail vehicle 1. This rail vehicle 1 comprises a first car 37, a second car 38, a third car 39, and, if appropriate, further cars, which are not illustrated in the figure. The first car 37 is the traction vehicle of the rail vehicle 1 and has a driver's cab 15 for the traction-vehicle driver for this.

In order to elucidate details, the second car 38 will now be considered. It has a first running gear 2 and a second running gear 3. The first car 37, the third car 39 and the further cars have further running gears, which are not illustrated in the figure. The first running gear 2 comprises a first wheel 40 and a second wheel 41, the two wheels 40 and 41 being rigidly connected to one another via a wheelset axle. A first brake shoe 42 of a first shoe-type braking unit 44 can be brought into contact with the first wheel 40, and a second brake shoe 43 of a second shoe-type braking unit 45 can be brought into contact with the second wheel 41. The first shoe-type braking unit 44 comprises, in addition to the first brake shoe 42, a pneumatic first brake cylinder 46, and the second shoe-type braking unit 45 comprises, in addition to the second brake shoe 43, a pneumatic second brake cylinder 47. The first brake cylinder 46 actuates the first brake shoe 42, and the second brake cylinder 47 actuates the second brake shoe 43.

The first brake cylinder 46 and the second brake cylinder 47 are activated by a brake controller 17. Electrical control signals from the first brake controller 17 are converted into compressed-air signals in an electropneumatic device 48 by analog converters, valves, compressed-air vessels, etc., and the compressed-air signals are communicated to the first brake cylinder 46 and the second brake cylinder 47.

Each wheel 40, 41 acts as a first friction element of a friction brake system of the rail vehicle 1, and similarly the respective associated brake shoe 42, 43 acts as a second friction element of the friction brake system. When the rail vehicle 1 is braking, the second friction elements are pressed against the first friction elements. In the process, the brake shoes 42, 43 act directly on the running surfaces of the wheels 40, 41 and not on a disk fastened to the wheel or the axle.

The second running gear 3 is structurally and functionally the same as the first running gear and also comprises shoe-type brake units with brake shoes, which can be brought into contact with wheels. The same can apply for the running gears of the other cars.

The use of brake shoes is advantageous, since they weigh less than other types of brakes and also require little space. Their use is indicated in particular when energy cannot be fed back into the network in the event of an electrical braking operation. Shoe-type brakes can also be used in combination with electric brakes, e.g., if a sudden rapid or safety braking action is necessary. i.e., the maximum braking force is to be applied.

With a wheel-rail system, rail vehicles, such as standard-gauge trains, underground trains and trams run on rail tracks by way of their wheels. Both the wheels and the railheads have suitable profiles for this. The interaction of the rail profile and the wheel profile is decisive for comfortable and safe running of a rail vehicle. Use is usually made of conically profiled, which is to say outwardly tapering, wheels for this. The aim of this conicity of the wheel profile is for the wheelset to self-center in a straight rail track without utilizing the wheel flanges.

In general, what is referred to as the equivalent conicity of the contact between wheel and rail determines the running properties of the rail vehicle. The equivalent conicity results in particular from the geometry of the running surface of the wheels, which is to say from the wheel profile, and the surface of the railhead, which is to say the rail profile. It is defined as the inclination of a conical wheel profile rolling on sharp edges that would produce the same wavelength of the sinusoidal motion of the running gear.

Furthermore, the equivalent conicity is also influenced by the gauge, with even small gauge narrowings causing an increase in the equivalent conicity owing to the progressive shape of the wheel profile.

The result of the conicity is that the bogie or running gear of the rail vehicle moves sinusoidally, i.e., travels slightly to the right and left alternately in a sinusoidal shape. This corresponds to an instability, which both reduces the driving comfort and also impairs the driving safety. The passengers notice the reduced driving comfort owing to vibrations, which are usually perceived as unpleasant, during the journey. In terms of the driving safety, displacements of the sleeper framework can arise, and these displacements can be caused or enhanced by high equivalent conicities.

In principle, it holds true that the running behavior of the rail vehicle is made worse as the equivalent conicity increases. This variable is influenced by wear and is therefore a central aspect in the maintenance of the vehicle and the infrastructure:
Owing to wheel wear, the conicity during driving operation increases owing to changes in the wheel profile. This results in reduced driving comfort and reduced running stability. This can be counteracted by taking maintenance measures such as reprofiling of the wheels, although this has adverse effects on the service life of the wheels of the rail vehicle. The use of shoe-type brakes increases the effect of the wheel wear. In embodiments, using them highly energetically can have a negative effect on the development of the conicity of the vehicle wheels. The result of this is that the driver has a strong influence on the development of the wheel profile: an anticipatory and careful driving style, avoiding strong braking operations with the shoe-type brakes, leads to a slower rise in the conicity of the wheels over time. The problem, however, is that the vehicle driver usually has no knowledge of the current state of the wheel profile, and therefore cannot align their driving behavior with it to reduce the aforementioned unfavorable effects.
As explained, the equivalent conicity results from the interaction between the wheel profile and the rail profile. The cause of reduced driving comfort or reduced running stability can thus also be ascribed to the track in addition to the described change in conicity of the wheel profile. In embodiments, changes in the profile of the railhead or gauge narrowings can cause an increase in the equivalent conicity. This can be counteracted by taking suitable maintenance measures, such as profiling grinding of the rails or adapting the rail attachment, both measures being complex and entailing high costs.

It follows from these points that the state of the vehicle wheels and the track should be extensively considered and, if appropriate, maintained. This is, however, currently not entirely the case: the current state of the rail profile and of the wheel profile is not continuously ascertained, and therefore it is not arranged for the wheel and/or rail to be subjected to maintenance at a suitable point in time, and the driver cannot be called on to drive in a way which protects the profile.

In order to improve this, the rail vehicle 1 has a conicity monitoring unit 16. A schematic sequence of the method carried out by the conicity monitoring unit 16 is shown in FIG. 2.

In the step STAB, the running stability of the vehicle is ascertained—according to a first criterion for estimating the development of conicity—by measurement. For this measurement of the vehicle reaction, according to FIG. 1 the vehicle comprises a measuring device 18 for monitoring the running stability. The running stability is monitored by acceleration measurements on the running gear frame. Here, the running behavior of the bogie is detected via the transverse acceleration of the bogie frame over the wheelset. The measured values from the measuring device 18 for monitoring the running stability are transmitted to the conicity monitoring unit 16, which can take the measured vehicle reactions as a basis to determine the extent of the instability of the vehicle 1.

It is therefore possible to draw conclusions about the equivalent conicity from the running behavior. To this end, the conicity monitoring unit 16 can convert the measured values from the measuring device 18 for monitoring the running stability either into continuous numerical values, which stand for the change in conicity or the current state of the wheel profile in terms of the conicity, or into discrete indications, such as “small increase” or “good profile state”, “average increase” or “sufficient profile state”, “strong increase” or “poor profile state”, “critical increase” or “very poor profile state”.

As already explained, the equivalent conicity results from the interaction between the vehicle and the rail. This means that the cause of the established instability cannot be established when considering the results from the measuring device 18 for monitoring the running stability alone.

As regards the cause of the instability in the vehicle, it is assumed in the present case that this instability is likely caused exclusively by degradation or wear of the wheel, and consequently a worsening wheel conicity. Another possible cause would be a defect on the hunting damper; however, this is rare, and it is assumed from this that degradation or failure of same can be ruled out by regular maintenance.

Therefore, the second step FS carried out—according to a second criterion for estimating the development of conicity—is detecting, by the conicity monitoring unit 16, the distance traveled since the last reprofiling of the wheels. For this, use is made of the known empirical law that the conicity of the wheels increases as the distance traveled increases. It is known from conicity-increase campaigns carried out beforehand, during which it is possible to precisely determine the conicity of a wheel in the event of an increase in conicity, how the wheel conicity develops on the basis of the mileage. This knowledge is utilized by the conicity monitoring unit 16.

In the simplest case, there is a linear relationship between an increase in distance and an increase in wheel conicity. In this case, it is possible to use a factor which is multiplied by the mileage after the last reprofiling. This factor can be specific to the rail network, e.g., to the German rail network, or to specific operation with particularly frequent curves. In Germany, the tracks are quite heterogeneous, such that it is possible to make use of a representative value, e.g., an average value over many tracks, which reproduces how the conicity of a wheel usually develops. If a rail vehicle only travels on a certain track section, a value specific to this track section can be ascertained and used for the calculation.

However, more complex relationships between an increase in distance and an increase in wheel conicity are also possible. In any case, the conicity monitoring unit 16 has access to a computation rule in order to determine a value for the increase in wheel conicity from the measured distance traveled. The conicity monitoring unit 16 can thus ascertain the increase in conicity owing to wheel wear from the detection of the distance traveled since the last reprofiling.

If both criteria are present, which is to say the first criterion for estimating the development of the conicity in step STAB, and the second criterion for estimating the development of the conicity in step FS, they can be compared with one another in step COMP. In this case, the measured vehicle reaction is thus set in relation to the predicted vehicle-related conicity, and the ascertained level of acceleration is therefore aligned with the predicted vehicle-related conicity.

If the first criterion of the step STAB indicates a large increase in the equivalent conicity, and the second criterion of the step FS also shows such, it is possible to draw the conclusion that the cause of the increase in the equivalent conicity is the wheel profile.
If the first criterion of the step STAB indicates a large increase in the equivalent conicity, and the second criterion of the step FS by contrast does not indicate such, or at least indicates a considerably smaller increase, it is possible to draw the conclusion that the likely cause of the increase in the equivalent conicity is the rail. In this case, there is thus an implausibility from the perspective of the rail vehicle, which is to say an identified unstable behavior of the vehicle together with a moderate vehicle-related increase in conicity owing to traveling a not especially long distance since the last wheel profiling. A reference to a track influence can therefore be established. If the first criterion of the step STAB does not indicate a significant increase in the equivalent conicity, this must likewise be the case for the second criterion of the step FS. In that case, an increase in conicity owing to deterioration of the wheel profile must imperatively be reflected in both criteria.

Since step FS predicts the vehicle-related increase in conicity in isolation, while step STAB determines an increase in conicity of the vehicle and/or rail, combining the two results makes it possible to specifically establish the cause as likely being the vehicle or the track. The combination described thus allows the cause of the increase in the equivalent conicity to be associated with the vehicle or the rail.

Depending on the result of the comparison in step COMP, one of the following measures is taken:

The measure OK means that nothing further is to be done at the moment. This is the case if the first criterion of the step STAB does not indicate a significant increase in the equivalent conicity.

The measure INFORM means that maintenance of the rail should be undertaken. This is the case if the comparison in step COMP has produced the result that the cause of the increase in the equivalent conicity is likely the rail. It is appropriate for this if the measured values from the measuring device 18 for monitoring the running stability are evaluated by the conicity monitoring unit 16 in conjunction with location-related information, in particular a GPS unit present in the vehicle or another satellite-assisted location method. As an alternative or in addition, point or line locating means that are present on the rails can be used to locate distinctive features of the track. These different methods make it possible to identify sections of the rails which are faulty. It is then possible to specifically check these sections as to whether the profile of the rails must be corrected or if a gauge narrowing that is to be rectified is present. To implement the measure INFORM, the conicity monitoring unit 16 outputs a corresponding message. For this, a suitable interface of the conicity monitoring unit 16 can be provided for communication regarding the maintenance of the track and the vehicle.

The measure INSTRUCT 1 means that it is necessary to consider maintenance of the wheel profile. This is the case if the cause of the increase in the equivalent conicity is likely the wheel profile. To implement the measure INSTRUCT 1, the conicity monitoring unit 16 outputs a corresponding message. The already mentioned interface for communication regarding eh maintenance of track and vehicle can be used for this.

While the described measures OK, INFORM, INSTRUCT 1 can be used for rail vehicles having any type of brakes, the measure INSTRUCT 2 is relevant only to vehicles with shoe-type brakes. This measure INSTRUCT 2 should be carried out, like the measure INSTRUCT 1, if it was established beforehand that the cause of the increase in the equivalent conicity is likely the wheel profile. If the vehicle is equipped with shoe-type brakes, this measure can be performed in addition or as an alternative to the measure INSTRUCT 1. In this case, the traction-vehicle driver can be instructed, for example by a display 14, shown in FIG. 1, in the driver's cab 15, to use the shoe-type brakes only gently, in order as a result to avoid adversely affecting the wheel profile any further. The driver is thus provided with a diagnostic message about the state of the wheel profile, e.g., in the form of a wheel state traffic light, and can adjust their braking behavior accordingly, in particular by driving in a way which generates low wear. A traffic light can indicate to the driver, in discrete values or by way of colors, exactly what the state of the wheel profiles is. Limit values for this are preset such that a way of driving which has an unfavorable effect on the development of the wheel profile and thus leads to uncomfortable driving or even driving which is hazardous to safety can be prevented by adjusting the way of driving or braking. The discrete indications described above, such as “small increase” or “good profile state”, “average increase” or “sufficient profile state”, “strong increase” or “poor profile state”, “critical increase” or “very poor profile state”, can be used to give the driver a signal.

For the decision as to which of the aforementioned measures OK, INFORM, INSTRUCT 1, INSTRUCT 2 should be carried out, the conicity monitoring unit 16 can have suitable rules stored in memory. For example, it is possible to provide limit values, possibly also for the difference between the two criteria, the failure to reach which or the exceeding of which speaks in favor of taking a measure. The conicity monitoring unit 16 can also have rules stored in memory for how frequently the step COMP is carried out, e.g., once per distance of a certain length traveled.

The rail vehicle stores the collected data of the criterion STAB and also the decision regarding the measures OK, INFORM, INSTRUCT 1, INSTRUCT 2 in memory, in combination with location-related information. If the same track section is traveled on repeatedly, it is possible to aggregate data about distinctive features of the track section on the train.

It is also advantageous to aggregate data from multiple rail vehicles on land, which is to say in a database outside the rail vehicle under consideration. This can be used by multiple trains to check the plausibility of distinctive features of the track section.

It is also possible to draw conclusions from such an aggregation about further, rare vehicle-related influences, e.g., a defective hunting damper, if only one rail vehicle among many exhibits a high degree of hunting, which cannot be caused by the wheel profile, at a defined location in the network.

The above explanations can—except for the optional measure INSTRUCT 2—be applied to a rail vehicle with or without shoe-type brakes. An additional procedure, which is specific to rail vehicles with shoe-type brakes, will be described below:

For this, on the one hand brake pressures of the friction brake system of the rail vehicle and on the other hand kinematic variables of the respective running gear are continuously detected. The brake pressures detected are cylinder pressures of the brake cylinders, which act as actuators for the shoe-type brake.

To this end, the conicity monitoring unit 16 comprises an energy observing means for detecting the braking energy dissipated by the shoe-type brake. As described in more detail below, this energy observing means calculates the friction power from the brake pressure and rotational speed signals or velocity signals and ascertains the increase in conicity from this.

To this end, the energy observing the conicity monitoring unit 16 is connected to a first detecting device 50, shown in FIG. 1, for detecting brake pressures of the friction brake system, which is in the form of a pressure measuring unit coupled to the first brake cylinder 46, and to a second detecting device 51 for detecting kinematic variables of the first running gear 2, which is in the form of a first tachometer coupled to the first wheel 40. It is also possible to detect not brake pressures, but braking forces or brake torques, with the result that the first detecting device 50 can be in the form of a load cell or torque sensor. The kinematic variables detected by the second detecting device 51 include speeds of the wheels and times; it is, however, also possible for the kinematic variable detected to be, for example, the driving speed of the rail vehicle 1.

The corresponding components may alternatively or additionally also be provided on the second wheel 41 and the associated shoe-type brake.

The energy observing means continuously ascertains friction powers and heat energies owing to friction between the first friction elements and the second friction elements from the detected variables, which is to say the brake pressures, rotational speeds and times, and also further known variables, specifically the coefficient of friction, proportionality factors, wheel radii. As an alternative, as has already been set out, it is possible for the friction power to be ascertained not on the basis of brake pressures, but on the basis of braking forces or brake torques.

First of all, the tangential forces between the first and the second friction elements are determined to ascertain the friction power from the brake pressures with the proportionality factors and the coefficients of friction, using known relationships between pressures and forces and between normal and tangential forces. The proportionality factors include cylinder and linkage transmission ratios, degrees of efficiency, etc. of the shoe-type brake units. Moreover, wheel circumferential speeds are determined from the rotational speeds with the wheel radii, using known kinematic relationships between rotational speeds or angular velocities and circumferential speeds. Friction power values are ascertained by multiplying the tangential forces by the circumferential speeds. Inputs of energy into the first friction elements, which is to say the wheels of the rail vehicle, are ascertained by multiplying the friction powers by the times.

The energy observing means thus makes the heat energy content of the wheels available to the conicity monitoring unit 16. This is based on an estimation, carried out by the explained relationships, of the heat energy stored in the wheel disk owing to braking operations that have taken place. This thermal energy content is converted into a change in wheel conicity via a computation rule stored in memory in the conicity monitoring unit 16 in the step ENERGY shown in FIG. 2. The background to this is that the input of heat into a wheel leads to deformations. When the wheels have a shoe-type brake, it is possible to make a prognosis about the increases in conicity on the basis of the braking energy in the meantime using test campaigns, from which such a computation rule can be created. Since this braking energy as described is detected by the energy monitoring means, it is possible to convert braking energy into an increase in conicity using the empirical laws ascertained beforehand.

Depending on the value of this change in wheel conicity determined in the step ENERGY, either the measure OK is performed, i.e., nothing is to be done presently, or the measure INSTRUCT 2 that was described above is performed. The conicity monitoring unit 16 uses a threshold value to make a decision as to when the measure INSTRUCT 2 is to be performed.

In the case of a vehicle with shoe-type brakes, both procedures, i.e., on the one hand via the steps STAB, FS, COMP and on the other hand via the step ENERGY, can be carried out. Since both procedures can lead to the measure INSTRUCT 2, it is possible to provide a common rule for arranging for this measure INSTRUCT 2 to be taken, e.g., a combined threshold value for the two branches that run via COMP and ENERGY.

The explained method is based essentially on an estimation of the development of wheel conicity in steps FS and ENERGY taking known empirical laws as a starting point. This allows engagement in good time, before uncomfortable driving behavior of the rail vehicle occurs. Since it is possible to identify a strong rise in the conicity before comfort-reducing vehicle reactions occur, a counteraction via maintenance or adjusted driving operation makes it possible to ensure safe and comfortable use of the rail vehicle. In embodiments, in addition to a reprofiling of the wheels, it is also possible for the traction-vehicle driver to modify the driving style, this affording considerable advantages for the service life of the wheels.

To carry out the explained method, the conicity monitoring unit 16 uses a computer program, which performs the calculations and outputs signals for carrying out the measures INFORM, INSTRUCT 1, INSTRUCT 2. The input variables used are data from the energy observing means, and the distance traveled since the last reprofiling of the wheels and data from the measuring device 18 for monitoring the running stability.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-14. (canceled)

15. A method for operating a rail vehicle comprising:
detecting a running stability of the rail vehicle using measurements;
determining a conicity prediction regarding a change in wheel profiles of the rail vehicle by a computer taking into account a distance traveled, wherein, for the conicity prediction, a distance traveled since a wheel profiling is measured and a computation rule is used to determine an expected change in wheel profiles of the rail vehicle from this; and
using the running stability and the conicity prediction to make a distinction between a track section-caused change and a vehicle-caused change in an equivalent conicity.

16. The method as claimed in claim 15, wherein data from a measuring device, which takes acceleration measurements on a running gear frame of the rail vehicle, are evaluated to detect the running stability.

17. The method as claimed in claim 15, wherein the distinction is made by comparing the running stability and the conicity predication with one another.

18. The method as claimed in claim 17, wherein, when making the distinction, a decision is made that the cause is the track section if the running stability indicates a greater change in the equivalent conicity than the conicity prediction, and a decision is made that the cause is the vehicle if the running stability indicates a similar change in the equivalent conicity to the conicity prediction.

19. The method as claimed in claim 15, wherein, if a decision is made that the cause is the track section, location-related information is additionally incorporated to make it possible to locate damage to the track section.

20. The method as claimed in claim 15, wherein the rail vehicle has shoe-type brakes, a heat energy content of the wheels is determined from detected data regarding braking operations that have taken place with the shoe-type brakes, wherein the data include brake pressures or braking forces or brake torques, and also kinematic variables such as wheel speeds or the running speed of the rail vehicle, and a computer makes a second conicity prediction regarding a change in wheel profiles of the rail vehicle from this.

21. The method as claimed in claim 20, wherein the distinction between a track-related cause and a vehicle-related cause is additionally made using the second conicity prediction.

22. The method as claimed in claim 15, wherein, after the distinction is made, one or more of the following measures are carried out:
outputting a message regarding defects on the rail,
outputting a message regarding defects on the wheels of the rail vehicle,
outputting a message to the driver regarding the wheel state or a future braking behavior.

23. A data processing device or system, comprising: means for carrying out the method as claimed in claim 15.

24. A computer program, comprising: instructions which, when the program is run by a computer, prompt the computer to carry out the method as claimed in claim 15.

25. A computer-readable data carrier, on which the computer program as claimed in claim 24 is stored.

26. A data carrier signal, which communicates the computer program as claimed in claim 24.

27. A data processing device or system, comprising means for receiving, evaluating and storing information from multiple rail vehicles as regards a distinction, made by a method as claimed in claim 15, between a track section-caused change and a vehicle-caused change in the equivalent conicity.
